(19) United States
(12) Patent Application Publication
(10) Pub. No.: US 2017/0293399 A1
(43) Pub. Date: Oct. 12, 2017

(54) COLLECTIVE COLLAGE GENERATION

(71) Applicant: Batch Labs, Inc., Valley View, OH (US)

(72) Inventor: Jesse Daniel Ewanko, Lakewood, OH (US)

(21) Appl. No.: 15/092,500

(22) Filed: Apr. 6, 2016

(51) Int. Cl. G06F 3/0481; H04L 12/58

(52) U.S. Cl. CPC G06F 3/0481; H04L 51/32

(57) ABSTRACT

Many computing projects involve an automated generation of a media collage from media captured from a variety of devices. Some projects may involve the collection of media from devices owned or operated by different users; however, coordinating the participation of the users in the collage project may be difficult. Presented herein are techniques for generating an automated media collage, wherein an initiating user designates an invitee list of invitees. The device of each invitee may present an invitation to participate in the media collage as a participant. For each invitee who agrees to participate, the device of the participant may automatically capture media according to the media capture invitation, and automatically transmit the media capture for inclusion in the collage. A media collage is generated from the media captures of the participants, and is transmitted to the device of each participant, which presents the media collage to the participant.

### BACKGROUND

Within the field of computing, many scenarios involve the automated generation of a media collage from a set of media captures that are captured by various devices, such as photos taken with a set of cameras. The devices may capture the media captures automatically or manually, and may submit the media captures to a server that aggregates the media captures into a media collage, such as an image panorama or a video or audio montage. The media collage generated from the media captures may be presented to a user, including an owner of one or more of the media capture devices, and/or a user who participated in the capturing of media.

In some such scenarios, the devices that generate the media captures may be owned and/or operated by different users. For example, a group of students in a classroom may collaborate in a project to take photos of a particular location with their individual cameras. The students may submit their photos to a server that assembles the photos as a photo collage for presentation to the students. In this manner, the group of students may participate in the capturing of media that is included in the media collage.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

While the capturing of media for a media collage project may involve the participation of a group of users, the coordination of the users and their devices may be difficult. As a first such example, in some scenarios, the users may participate only by first voluntarily discovering the media collage project; users who are not aware of the media collage project may miss the opportunity to participate. As a second such example, in some scenarios, the user may not fully understand the objectives of the media collage project, such as when, where, or what kind of media to capture. Discrepancies between the details of the media collage project and the media captured by a participant may lead to undesirable deviance from the objectives of the media collage project. As a third such example, in some scenarios, the user may not understand or remember how or where to submit captured media for inclusion, and/or how or where to view the media collage when it is later completed.

Presented herein are techniques for configuring a set of media capture devices to participate in the collection of media captures for a media collage. In accordance with these techniques, an initiating user may designate, from a list of associate users (e.g., the user's contacts or social network), an invitee list of invitees. An invitation to become a participant in the media collage may be transmitted to the device of each invitee, and the devices may present the invitation to the invitees (e.g., identifying the initiating user and describing details of the media collage project, such as the date, time, and type of media to be captured). When an invitee accepts the invitation to participate, the device of the participant may automatically generate a media capture in accordance with the invitation. The devices of the participants may transmit the media captures to a server that collects and aggregates the media captures into a media collage, and transmits the media collage to the devices of the participants, and the devices of the participants may present the received media collage to the participant. In this manner, the devices of the participants facilitate and coordinate the participation of the users; the collection and aggregation of media captures in accordance with the invitation; and the generation and presentation of the media collage to the participants, in accordance with the techniques presented herein.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an example scenario featuring the generation of a media collage from a set of devices.

FIG. 2 is an illustration of an example scenario featuring the generation of a media collage from a set of devices in accordance with the techniques presented herein.

FIG. 3 is a flow diagram illustrating an example first method of configuring a device to facilitate the generation of a media collage in accordance with the techniques presented herein.

FIG. 4 is a flow diagram illustrating an example second method of configuring a device to facilitate the generation of a media collage in accordance with the techniques presented herein.

FIG. 5 is a flow diagram illustrating an example third method of configuring a device to facilitate the generation of a media collage in accordance with the techniques presented herein.

FIG. 6 is a system diagram of a set of devices that collectively generate a media collage in accordance with the techniques presented herein.

FIG. 7 is an illustration of an example computer-readable medium comprising processor-executable instructions that cause a device to facilitate the generation of a media collage in accordance with the techniques presented herein.

FIG. 8 is an illustration of an example scenario featuring a suggestion process for suggesting an invitee list for a media collage project to an initiating user in accordance with the techniques presented herein.

FIG. 9 is an illustration of an example scenario featuring a user interface process for presenting an invitation of a media collage project to an invitee in accordance with the techniques presented herein.

FIG. 10 is an illustration of an example scenario featuring a user interface process for generating a media capture for submission to a media collage project in accordance with the techniques presented herein.

FIG. 11 is an illustration of an example scenario featuring various media aggregation techniques for generating a media collage from a set of media captures in accordance with the techniques presented herein.

FIG. 12 illustrates an example computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

### A. Introduction

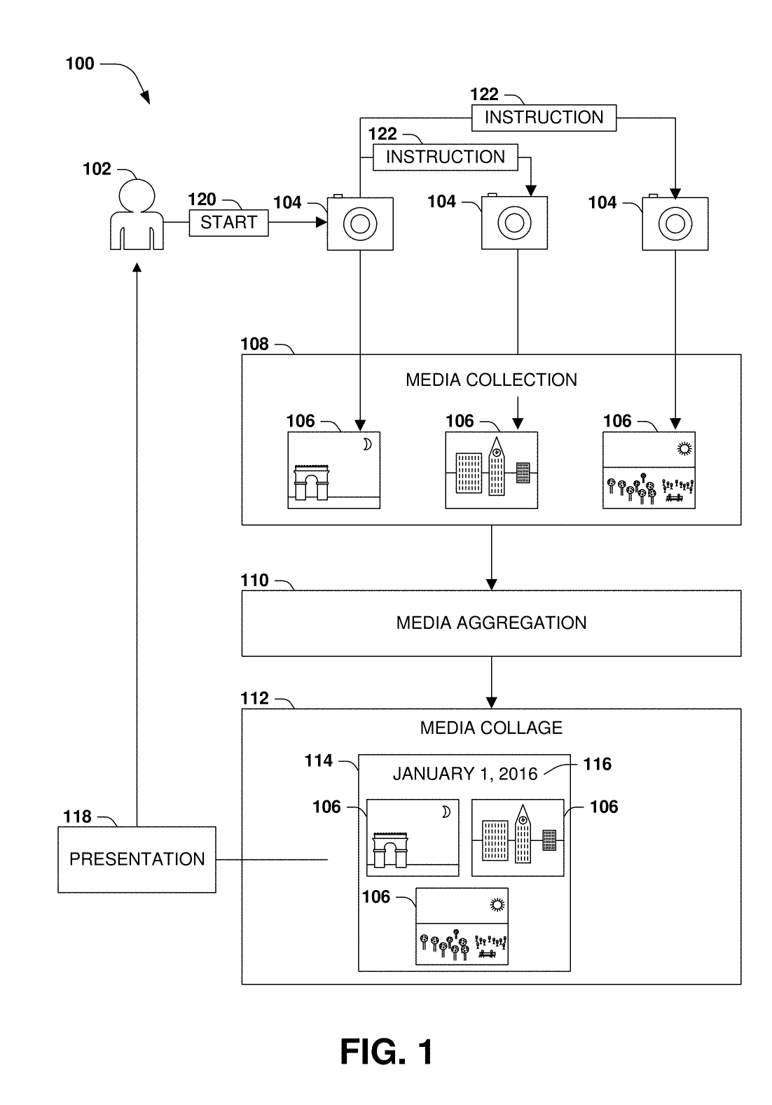

FIG. 1 is an illustration of an example scenario 100 featuring a media collage 112 generated from a media collection 108 of media captures 106 respectively captured by one of a collection of devices 104.

In this example scenario 100, a user 102 utilizes a set of devices 104, such as cameras, to capture a set of images. The user 102 may initiate the process with a start command 102 issued to a first device 104, which generates a media capture 106, and which also transmits instructions 122 to the other devices 104 to generate additional media captures 106. The media collection 108 of media captures 106 may be processed through media aggregation 110 to produce a media collage 112 (such as an aggregated image 116), wherein respective media captures 106 are positioned within the media collage 112 according to a desirable organizational scheme (e.g., organized by location, by device, or by chronology). The media aggregation 110 may be achieved through an automated media aggregation technique, a manual design technique, or a combination thereof. The media collage 112 may also include other information, such as the date 116 upon which the media collection 108 was captured. Upon completion of the media aggregation 110, the media collage 12 may be included in a presentation 118 to the user 102.

In scenarios such as the example scenario 100 of FIG. 1, the user 102 may utilize a collection of devices 104 for the media collection 108. However, in some such scenarios, a set of users 102 may respectively operate a device 104 such as a camera, and each user 102 may generate a media capture 106 at a desired time and location, and the media aggregation 110 may therefore represent a media collage project involving media captures 106 by a variety of users. For example, a classroom of students may choose to participate in a media collage project on a field trip, and each student may generate one or more media captures 106 using a device 104 such as the students' mobile phones or cameras. The media collage 112 may therefore represent the contributions of a set of users 102 to the media collection 108.

However, in many such scenarios, the collective participation of a set of users 102 may significantly depend upon the individual efforts of each such user 102. Such dependency may result in a variety of difficulties that diminish the results of the media collage project.

As a first such example, in some scenarios, the users 102 may participate only after voluntarily discovering the media collage project. For example, a first user 102 may initiate a media collage project to which a second user 102 may be eager to contribute, but the second user 102 may not learn of the project until after the completion of the media collage 112. Alternatively or additionally, the initiating user 102 may deliberately communicate with each other user 102 who may be interested in participating in the media collage 112, but such user-driven communication may be inefficient and prone to miscommunication. The initiating user 102 may also fail to identify particular other users 102 who may be eager to participate in the media collage project until after the media capturing and/or media aggregation 110.

As a second such example, in some scenarios, a user 102 may not fully understand the objectives of the media collage project, such as when, where, or what kind of media to capture. The user 102 may therefore generate a media capture 106 of a location, date, or media type that does not match the other media captures 106 of the media collection 108, and that may therefore be excluded from the media collage 112, or may be included but may diminish the coherence of the media collage 112.

As a third such example, in some scenarios, the user may not understand or remember how or where to submit captured media for inclusion. For example, the user 102 may not be able to locate a website, service, server, device, or email address to which the user's media capture 106 is to be submitted after completion, or may simply not remember to submit the media capture 106 for inclusion in the media collage 112. The failure or inefficiency of relegating the submission process to each user 102 may result in a number of failures to submit media captures 106, even if such media captures 106 were duly collected in accordance with the media collage project. The resulting media collection 108, and consequently the media collage 112, may therefore not include some of the media captures 106 that are not received in time for the media aggregation 110.

As a fourth such example, the users 102 may not understand or remember how to retrieve and view the media collage 112. Such users 102 may therefore fail to receive a presentation 118 of the media collage 112 including their media capture 106. These and other disadvantages may arise from the incomplete manner in which the devices 104 assist the users 102 in coordinating the collection, submission, and aggregation of media captures 106 for the media collage 112, and the transmission of the media collage 112 back to the devices 104 of the users 102 for presentation.

### B. Presented Techniques

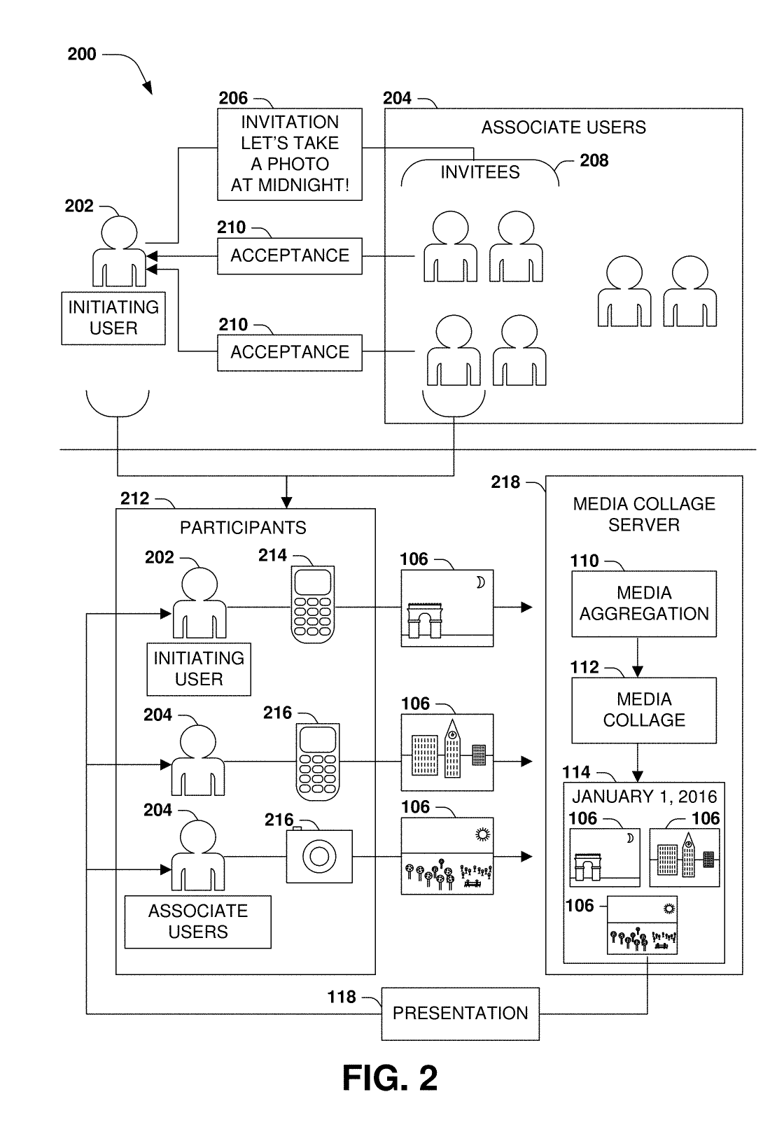

FIG. 2 is an illustration of an example scenario 200 featuring techniques for configuring devices to assist users 102 in the capturing and aggregation of media captures 106 for a media collage 112 in accordance with the techniques presented herein.

In this example scenario 200, an initiating user 202 has a set of associated users 204, such as a set of contacts identified in an address book, a social network, a directory, or a mailing list. Among the associate users 204, the initiating user 202 may choose a set of invitees 208 for the media collage 112, and may initiate an invitation 206 (only) to such invitees 208 to participate in the media collage project. An initiating device 214 of the initiating user 202 may transmit the invitation 206 to the devices 104 of the respective invitees 208, and each device 104 may present to the invitee 208 an invitation 206 to become a participant 212 in the media collage 112, optionally including information describing the name, location, date, and/or objectives of the media captures 106 for the media collage 112. The respective invitees 208 may review the invitation 206, and may choose to accept (and become a participant 212 along with the initiating user 202), or decline the invitation 206 (either by transmitting an explicit notification that declines the invitation 206, or by refraining from transmitting an acceptance 210). In the former case, the device 104 of the invitee 208 may transmit the acceptance 210 in response to the invitation 206.

The participants 212 of the media collage project (including the initiating user 202 and the associate users 204 who received and accepted an invitation 206) may utilize their devices (respectively, an initiating device 214 and various associate devices 216 of the associate users 204) to generate media captures 106 in accordance with the invitation 206. The devices 104 of the participants 212 may submit the media captures 106 to a media collage server 218, which performs a media aggregation 110 of the received media captures 106 to produce a media collage 112 (such as an aggregated image 114 where the photos taken by the respective participants 212 are arranged according to a layout, such as a spatial, chronological, subject-matter, or rating-based layout). The media collage server 218 may transmit the aggregated image 114 to the participant devices of the participants 212 (including the initiating device 214 of the initiating user 202), each of which may feature the media collage 112 in a presentation 118 to the participant 212. In this manner, the participants 212 collaboratively produce a media collage 112 in accordance with the techniques presented herein.

### C. Examples of Technical Advantages

The use of the techniques presented herein to generate a media collage 112 may present a variety of technical advantages, as compared with other techniques for generating media collages 112.

As a first such example, the techniques presented herein may facilitate the coordination of the participant devices (including the initiating device 214 of the initiating user 202, and the associate devices 216 of the associate users 204) to organize the capturing of the media collage 112. For example, the invitation 206 may include the details specified by the initiating user 202, which may be accurately communicated to each invitee 208 and persisted as a record of the location, time, objectives, and other details of the media collage 112, rather than depending upon the understanding, memory, and cooperation of the respective participants 204. In various embodiments, the invitation 206 may specify the invitees 208 as a specific set of individuals, or as any individuals meeting a particular set of criteria (e.g., any residents of a particular city). In other embodiments, the invitees 208 may be specified as any member of the public who wishes to contribute to the media collage 112; e.g., a publicly posted media collage project may invite the user of any device to join the initiative, and may gather and aggregate the media collage 112 from any member of the public who submits a piece of media for inclusion.

As a second such example, the techniques presented herein may facilitate the configuration of the respective participant devices to participate in the media capture 106 for the media collage 112. For example, the invitation 206 may include details that configure the participant device of each participant to initiate the media capture 106 at a date and/or of a media type that are specified in the invitation 206 (e.g., if an invitee 208 accepts the invitation 206, the participant device of the invitee 208 may create an automated trigger to generate the media capture 106 at the date and time specified in the invitation 206). The participant devices may also utilize this information to assist the respective participants 212, e.g., by reminding the participant 212 about the media collage 112 shortly before the time to generate the media capture 106, optionally presenting with the reminder details specified in the invitation 206, such as the location or subject of the media capture 106 for the media collage 112, to assist the participant 212 in generating a suitable media capture 106 using the participant device.

As a third such example, the techniques presented herein may include an automated submission of the media capture 106 from the respective participant devices to a media collage server 218, which may perform a media aggregation 110 and transmit the media collage 112 to the respective participant devices for presentation to the participant 212. Such automated submission, transmission, and presentation may facilitate the completion of the media collage project, and may avoid difficulties that arise if a participant 212 does not successfully submit the media capture 106 to the media collage server 218 and/or remember to visit a website in order to view the media collage 112 after the media aggregation 110. The automated configuration of the participant devices to complete the participation of the participant 212 in the media collage project may therefore improve the odds of the completion of the media collage project.

As a fourth such example, the techniques presented herein may enable associate users 204 to participate in a media collage project in a manner that, compared with other techniques, safeguards the privacy and control of the associate user 204 over the associate device 216. For example, some techniques for collaborative media collage generation transfer or delegate control of the associate device 216 to the initiating user 202, who may issue instructions 122 to the associate device 216 to perform media capture; however, some associate users 204 may be uncomfortable or unwilling to delegate control to another user, and may prefer to utilize some variations of the techniques presented herein, where the associate device 216 may automatically or semi-automatically capture media in a manner wherein the associate user 204 retains control. As another such example, the privacy interests of the initiating user 202 and/or associate users 204 may be safeguarded, e.g., by conditioning the capturing of media upon the consent of the associate user 204 as expressed by an acceptance of the invitation; by enabling the initiating user 202 to control the selected set of invitees 208 (such as in a private group), and/or by allowing the associate users 204 to opt in or out of such invitations 206 and media collage projects; by anonymizing the media captures 106 that are included in the media collage 112; and/or by restricting the transmission of the media collage 112 only to the participants 212 of the media collage 112. These and other technical advantages may be achievable in the context of media collage projects in accordance with the techniques presented herein.

### D. Examples of Embodiments

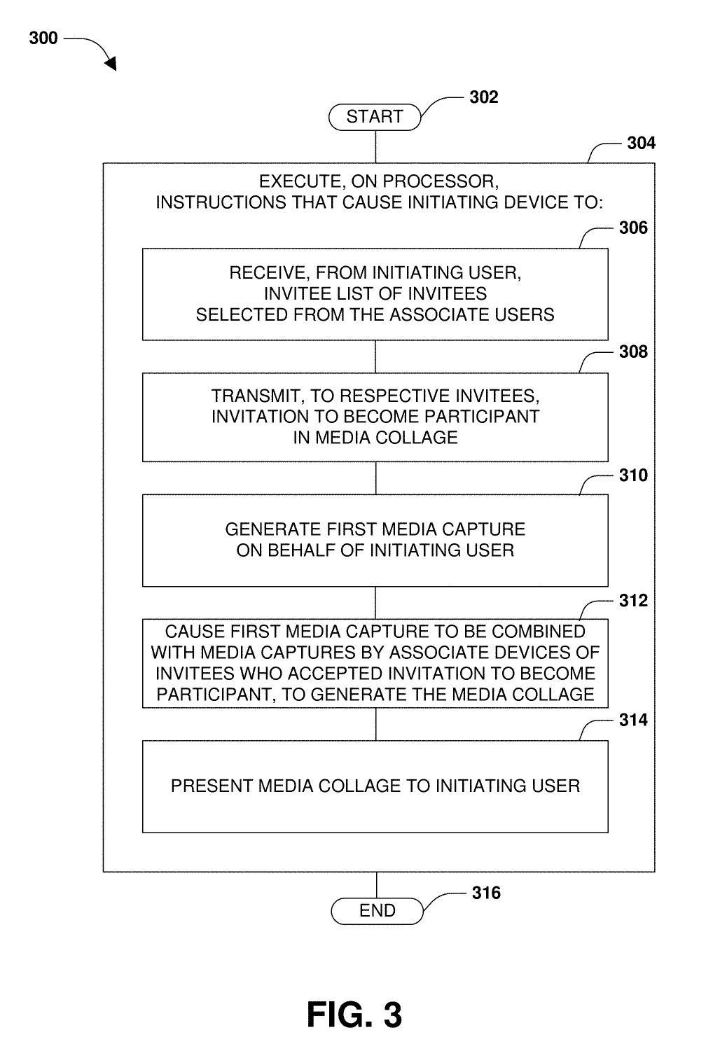

FIG. 3 presents a first example embodiment of the techniques presented herein, illustrated as an example method 300 of generating a media collage 112 using associate devices 216 of associate users 204 and an initiating device 214 of an initiating user 202. The example method 300 may utilize an initiating device 214 having a processor and a memory, and may be implemented, e.g., as a set of instructions stored in a memory component of the initiating device 214 (e.g., a memory circuit, a platter of a hard disk drive, a solid-state memory component, or a magnetic or optical disc) that, when executed by a processor of the initiating device 214, cause the initiating device 214 to operate in accordance with the techniques presented herein.

The example method 300 begins at 302 and involves executing 304 the instructions on the processor. Specifically, execution of the instructions causes the initiating device 214 to receive 306, from the initiating user 202, an invitee list 206 of invitees 208 selected from the associate users 204. Execution of the instructions further causes the initiating device 214 to transmit 308, to respective invitees 208, an invitation 206 to become a participant 212 in the media collage 112. Execution of the instructions further causes the initiating device 214 to generate 310 a first media capture 106 on behalf of the initiating user 202. Execution of the instructions further causes the initiating device 214 to cause 312 the first media capture 106 to be combined with media captures 106 by the associate devices 216 of respective invitees 208 who accepted the invitation 206 to become a participant 212, wherein combining the first media capture 106 and the media captures 106 of the other participants 212 generates the media collage 112. Execution of the instructions further causes the initiating device 214 to present 314 the media collage 112 to the initiating user 202. In this manner, the example method 300 achieves the generation of the media collage 112 as a collaboration of the participants 212 through the specific configuration of the participant devices in accordance with the techniques presented herein, and so ends at 316.

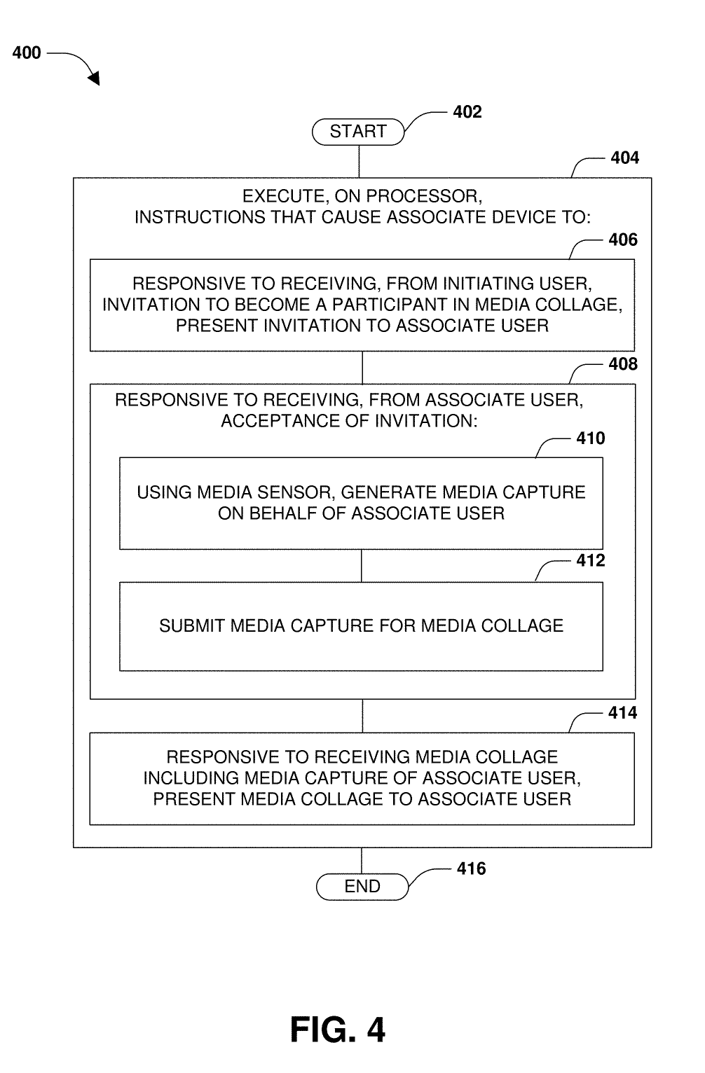

FIG. 4 presents a second example embodiment of the techniques presented herein, illustrated as an example method 400 of enabling an associate user 240 to participate in a media collage 112. The example method 400 may utilize an associate device 216 of the associate user 204, wherein the associate device 216 comprises a processor, a memory, and a media sensor, such as a photosensitive array of a still camera or videocamera, or a microphone array. The example method 400 may be implemented, e.g., as a set of instructions stored in a memory component of the associate device 216 (e.g., a memory circuit, a platter of a hard disk drive, a solid-state memory component, or a magnetic or optical disc) that, when executed by a processor of the associate device 216, cause the associate device 216 to operate in accordance with the techniques presented herein.

The second example method 400 begins at 402 and involves executing 404 the instructions on the processor. Specifically, execution of the instructions causes the associate device 216 to, responsive to receiving, from an initiating user 202, an invitation 206 to become a participant 212 in the media collage 112, present 406 the invitation 206 to the associate user 204. Execution of the instructions further causes the associate device 216 to, responsive 408 to receiving, from the associate user 204, an acceptance of the invitation 206, generate 410 a media capture 216 on behalf of the associate user 204 using the media sensor in accordance with the invitation 206, and submit 412 the media capture 106 for the media collage 112. Execution of the instructions further causes the associate device 216 to, responsive to receiving the media collage 112 including the media capture 106 of the associate user 204, present 414 the media collage 112 to the associate user 204. In this manner, the second example method 400 enables the associate user 204 to participate in the media collage 112 in accordance with the techniques presented herein, and so ends at 416.

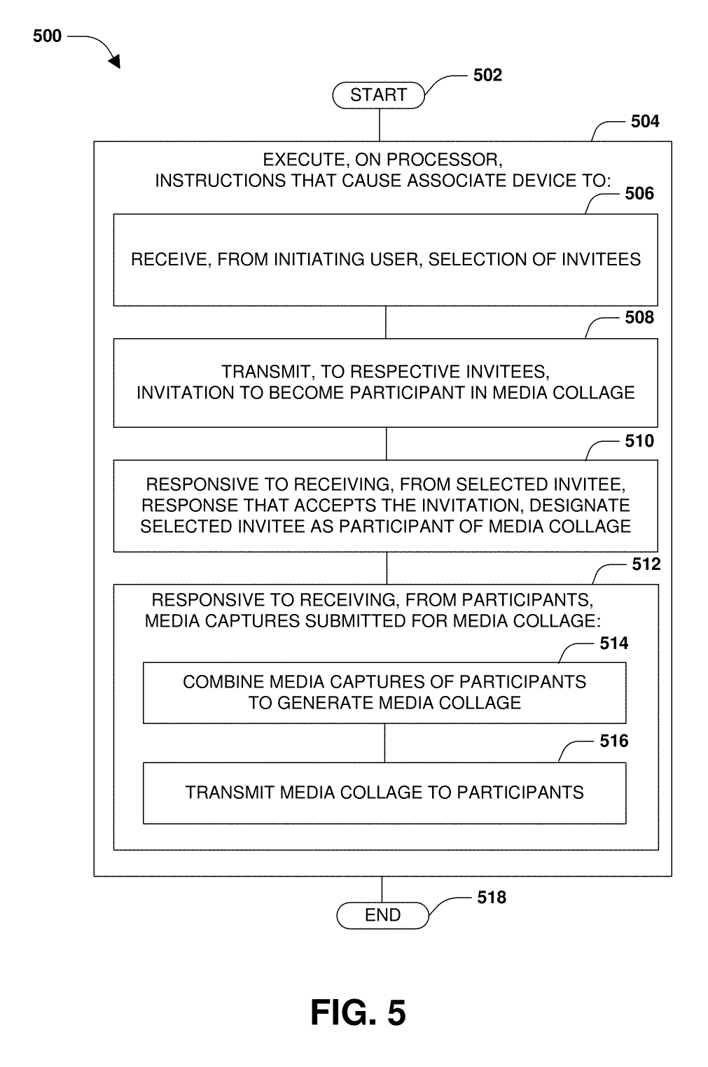

FIG. 5 presents a third example embodiment of the techniques presented herein, illustrated as an example method 500 of enabling generating a media collage 112 using media captures 106 generated by an initiating device 214 of an initiating user 202 and associate devices 216 of associate users 204 who are participants 212 in the media collage 112. The example method 500 may utilize a media collage server 218 comprising a processor and a memory. The example method 500 may be implemented, e.g., as a set of instructions stored in a memory component of the media collage server 218 (e.g., a memory circuit, a platter of a hard disk drive, a solid-state memory component, or a magnetic or optical disc) that, when executed by a processor of the media collage server 218, cause the media collage server 218 to operate in accordance with the techniques presented herein.

The third example method 500 begins at 502 and involves executing 504 the instructions on the processor. Specifically, execution of the instructions causes the media collage server 218 to receive 506, from the initiating user 202, a selection of invitees 208 selected from a set of associate users 204. Execution of the instructions further causes the media collage server 218 to transmit 508, to respective invitees 208, an invitation 206 to become a participant 212 in the media collage 112. Execution of the instructions further causes the media collage server 218 to, responsive to receiving, from a selected invitee 208, a response that accepts the invitation 206, designate 510 the selected invitee 208 as a participant 212 of the media collage 112. Execution of the instructions further causes the media collage server 218 to, responsive 512 to receiving, from the participants 212, media captures 106 submitted for the media collage 112, combine 514 the media captures 106 of the participants 212 to generate the media collage 112, and transmit 516 the media collage 112 to the participant devices for presentation to the participants 212. In this manner, the third example method 500 enables the media collage server 218 to generate and distribute the media collage 112 in accordance with the techniques presented herein, and so ends at 518.

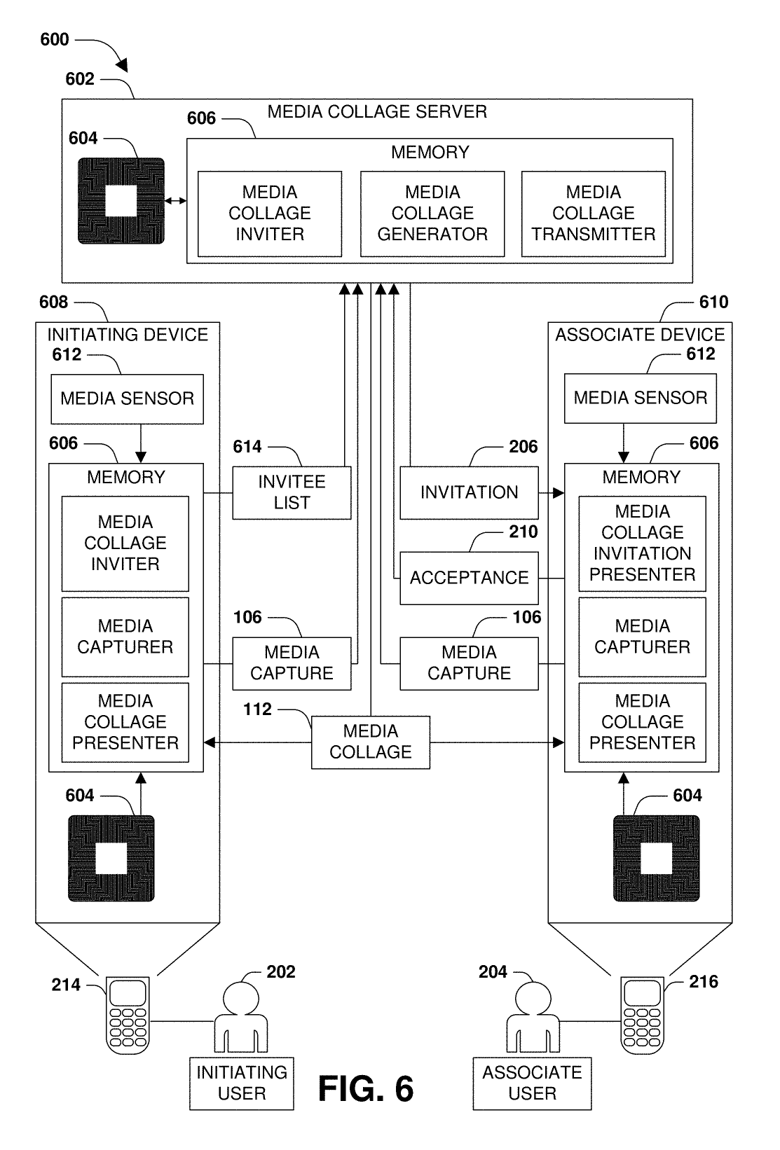

FIG. 6 is an illustration of an example scenario 600 featuring system diagrams of various devices that may interoperate to generate a media collage 112 in accordance with the techniques presented herein.

The example scenario 600 of FIG. 6 features a media collage server 620 comprising a processor 604 and a memory 606 storing instructions that, when executed by the processor 604, provide a system that causes the media collage server 602 to operate according to the techniques presented herein. The example scenario 600 of FIG. 6 also features an initiating device 608 comprising a media sensor 612; a processor 604; and a memory 606 storing instructions that, when executed by the processor 604, provide a system that causes the initiating device 608 to operate according to the techniques presented herein. The example scenario 600 of FIG. 6 also features an associate device 610 comprising a media sensor 612; a processor 604; and a memory 606 storing instructions that, when executed by the processor 604, provide a system that causes the associate device 610 to operate according to the techniques presented herein. It is to be appreciated that each of the devices in this example scenario 600 implements a portion of the techniques presented herein, and that, while the interoperation of the devices results in the generation and presentation of media collage 112, the operation of each such device presents a specific embodiment of the techniques presented herein.

In the example scenario 600 of FIG. 6, execution of the instructions stored in the memory 606 causes the media collage server 602 to operate in the following manner. The media collage server 602 receives, from the initiating user 202, a selection of invitees 208. The media collage server 602 also transmits, to respective invitees 208, an invitation 206 to become a participant 212 in the media collage 112. The media collage server 602 also, responsive to receiving, from a selected invitee 208, a response that accepts the invitation 206, designates the selected invitee 208 as a participant 212 of the media collage 112. The media collage server 602 also, responsive to receiving, from the participants 212, media captures 106 submitted for the media collage 112, combines the media captures 112 of the participants 212 to generate the media collage 112, and transmits the media collage 112 to the participants 212.

In the example scenario 600 of FIG. 6, execution of the instructions stored in the memory 606 causes the initiating device 608 to operate in the following manner. The initiating device 608 receives, from the initiating user 202, an invitee list of invitees 208 selected from the associate users 204. The initiating device 608 also transmits, to respective invitees 208, an invitation 206 to become a participant 212 in the media collage 112. The initiating device 608 also generates a first media capture 106 on behalf of the initiating user 202. The initiating device 608 also causes the first media capture 106 to be combined with media captures 106 by the associate devices 216 of respective invitees 208 who accepted the invitation 206 to become a participant 212, wherein combining the first media capture 106 and the media captures 106 of the other participants 212 generates the media collage 112. The initiating device 608 also presents the media collage 212 to the initiating user 202.

In the example scenario 600 of FIG. 6, execution of the instructions stored in the memory 606 causes the associate device 610 to operate in the following manner. The associate device 610, responsive to receiving, from an initiating user 202, an invitation 206 to become a participant 212 in the media collage 112, presents the invitation 206 to the associate user 204. The associate device 610 also, responsive to receiving, from the associate user 204, an acceptance of the invitation 206, generates a media capture 106 on behalf of the associate user 204 using the media sensor 612. The associate device 610 also submits the media capture 106 for the media collage 112. The associate device 610 also, responsive to receiving the media collage 112 including the media capture 106 of the associate user 204, presents the media collage 112 to the associate user 204. In this manner, the systems presented in the example scenario 600 of FIG. 6 enable the devices to interoperate to achieve the generation of the media collage 112 in accordance with the techniques presented herein.

Still another embodiment involves a computer-readable medium comprising processor-executable instructions configured to apply the techniques presented herein. Such computer-readable media may include, e.g., computer-readable storage media involving a tangible device, such as a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD-R, DVD-R, or floppy disc), encoding a set of computer-readable instructions that, when executed by a processor of a device, cause the device to implement the techniques presented herein. Such computer-readable media may also include (as a class of technologies that are distinct from computer-readable storage media) various types of communications media, such as a signal that may be propagated through various physical phenomena (e.g., an electromagnetic signal, a sound wave signal, or an optical signal) and in various wired scenarios (e.g., via an Ethernet or fiber optic cable) and/or wireless scenarios (e.g., a wireless local area network (WLAN) such as WiFi, a personal area network (PAN) such as Bluetooth, or a cellular or radio network), and which encodes a set of computer-readable instructions that, when executed by a processor of a device, cause the device to implement the techniques presented herein.

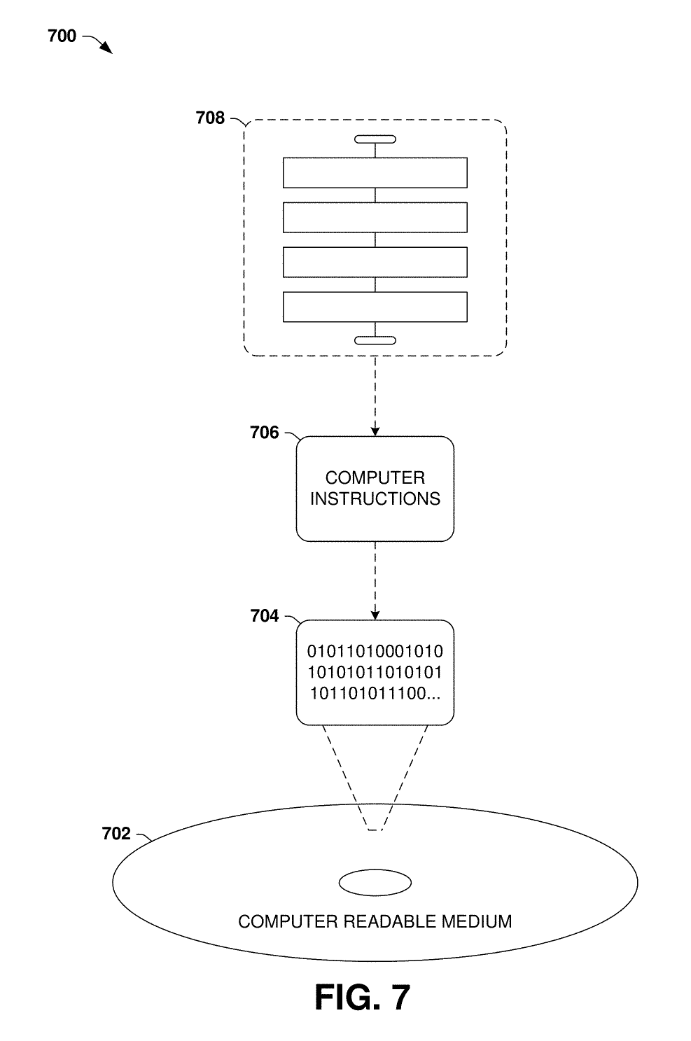

An example computer-readable medium that may be devised in these ways is illustrated in FIG. 7, wherein the implementation 700 comprises a computer-readable medium 702 (e.g., a CD-R, DVD-R, or a platter of a hard disk drive), on which is encoded computer-readable data 704. This computer-readable data 704 in turn comprises a set of computer instructions 706 configured to operate according to the principles set forth herein. In one such embodiment, the processor-executable instructions 706 may be configured to, when executed by a processor of a device, cause the device to participate in the generation of the media collage 112, such as the first example method 300 of FIG. 3; the second example method 400 of FIG. 4; and/or the third example method 500 of FIG. 5. In another such embodiment, the processor-executable instructions 706 provide a system that causes a device (such as the media collage server 602, the initiating device 608, and/or the associate device 610 in the example scenario 600 of FIG. 6) to utilize the techniques presented herein. Some embodiments of this computer-readable medium may comprise a nontransitory computer-readable storage medium (e.g., a hard disk drive, an optical disc, or a flash memory device) that is configured to store processor-executable instructions configured in this manner. Many such computer-readable media may be devised by those of ordinary skill in the art that are configured to operate in accordance with the techniques presented herein.

### E. Variable Aspects

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments to confer individual and/or synergistic advantages upon such embodiments.

### E1. Examples of Scenarios and Architectures

A first aspect that may vary among embodiments of these techniques relates to the scenarios wherein such techniques may be utilized. As a first variation of this first aspect, these techniques

As a first variation of this first aspect, the initiating user 202 may choose invitees 208 from among many types of associate users 204, such as contact in an address book stored on the initiating device 214; social networks, including academic and professional networks; chat services; and organization directories.

As a second variation of this first aspect, the techniques presented herein may be utilized with various types of media, including still images such as drawings and photographs; video sequences; audio recordings; text, documents, and web pages; and computer-generated graphics, as well as combinations thereof. Such media may also be captured by a variety of media sensors 612, such as monochromatic and/or polychromatic photosensitive arrays of cameras, microphones, and user input devices such as touch-sensitive displays and drawing tablets.

As a third variation of this first aspect, the techniques presented herein may implemented using a variety of devices, such as workstations; servers; laptops; tablets; palmtop form-factor computers; mobile phones and/or media players; game consoles; appliances; wearable computing devices, such as computing-enabled wristwatches and eyeglasses; and vehicle computers, such as drone cameras. The devices may also be stationary as well as portable, such as a desktop computer with an attached camera.

As a fourth variation of this first aspect, the techniques presented herein may be implemented using various architectures. As a first such example, while the example scenario 600 of FIG. 6 includes a media collage server 602 as a separate device, some embodiments may incorporate part or all of the media collage server 602 in the initiating device 214 of the initiating user 202 and/or the associate device 216 of the associate user 204. For example, in some architectures, the initiating device 214 and/or associate devices 216 may operate in a decentralized peer-to-peer manner, wherein each device transmits a media capture 106 to the other devices, such that the device of each participant 212 in the media collage 112 receives each of the individual media captures 106, and may therefore generate a media collage 112 for transmission to some or all of the other devices and participants 212. Conversely, the media collage server 602 may be implemented as two or more servers, such as a first server that receives the invitee list 614 and transmits invitations 206, a second server that collects the media captures 106 and performs the media aggregation to generate the media collage 112, and a third server that transmits the media captures 106 to the initiating device 604 and/or the associate devices 216. As a second such example, while the example scenario 600 of FIG. 6 illustrates the initiating device 608 transmitting the invitee list 614 to the media collage server 602 and the media collage server 602 transmitting invitations 206 to the associate devices 610, some embodiments may cause the initiating device 608 to transmit invitations 206 directly or indirectly to the associate devices 610 without using the media collage server 602. As a third such example, while the example scenario 600 of FIG. 6 illustrates the associate device 216 transmitting an acceptance 210 to the media collage server 602 in addition to the media capture 106, in some embodiments the associate device 610 may not separately transmit an acceptance 210, but may transmit the media capture 106 as an implied acceptance 210 of the invitation 206. Those of ordinary skill in the art may devise many variations in the scenarios in which the techniques presented herein may be utilized, and in the variations of devices and architectures used to achieve the application of the techniques presented herein.

### E2. Formulation, Contents, and Transmission of Invitations

A second aspect that may vary among embodiments of the techniques presented herein relates to the formulation, contents, and/or transmission of invitations 206 from the initiating user 202 to the associate users 204 to participate in a media collage 112.

As a first variation of this second aspect, the initiating device 214 may have access to an associate user list of associate users 204 of the initiating user 202, such as an address book of a contacts database. The selection of invitees may further comprise, among the associate users 204 of the initiating user 202, identifying a subset of suggested invitees; presenting, to the initiating user 202, a suggestion comprising the suggested invitees for the media collage 112; and receiving, from the initiating user 202, a selection of invitees 208 from among the suggested invitees. As one such example, the media collage 112 described in the invitation 206 may further comprise a collage of media captures of a selected media type, such as a media collage of images, video, or sound recordings. The identification of the suggested invitees may therefore involve determining whether the associate users 204 for which the associate device 216 is capable of capturing the selected media type, and identifying the subset of suggested invitees that have associate devices 216 that are capable of capturing the selected media type.

As a second variation of this second aspect, the initiating user 202 may, in addition to selecting invitees 208 from the associate users 204, specify a selection of a media capture sequential order in which the participants 212 are to generate the media captures 106 for the media collage 112 (e.g., an indication of the order in which participants 212 are to capture images). The invitation 206 may therefore be transmitted with the media capture sequential order for the participants 212.

As a third variation of this second aspect, the invitation 206 to participate in the media collage 112 may further comprise a description of the media collage 112 provided by the initiating user 202 and/or one or more associate users 204, such as a subject that is to be the focus of the images comprising the media collage 112. An embodiment may therefore transmit, with the invitation 206, the description of the media collage 112.

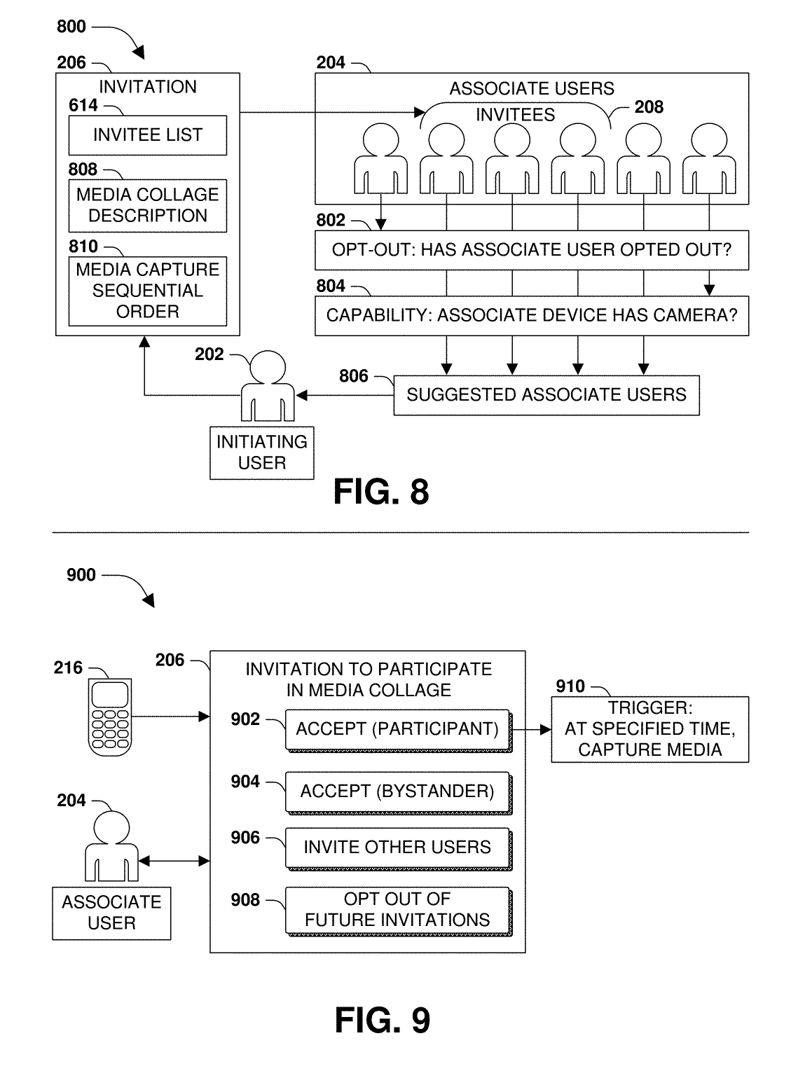

FIG. 8 is an illustration of an example scenario 800 featuring several such variations in the invitation 206. As a first such example, the initiating device 214 of the initiating user 202 may initially select, from the associate users 204 of the initiating user 202 a set of suggested associate users 806 who the initiating user 202 may wish to select as invitees 208 to participate in the media collage 112. Such selection may include, e.g., a consideration of which associate users 204 have opted out 802 of media collages 112, and/or which associate users 204 have previously agreed to participate in media collages 112. Such selection may also include, e.g., an evaluation of the capabilities 804 of the associate devices 216 of the associate users 204, to limit the suggested associate users 806 to those who have an associate device 216 that is capable of capturing the media captures 106 to be included in the media collage 112. As a second such example, the initiating user 202 specifies a media collage description 808 of the media collage to be aggregated from the media captures 106 of the participants 212, as well as a media capture sequential order 810 in which the participants 212 who accept the invitation are to capture the media captures 106. For example, the initiating user 202 may choose a media capture sequential order 810 for the invitees 208 who accept the invitation 206; invitees 208 may select a position in the media capture sequential order 808 while accepting the invitation 206; and/or the media capture sequential order 810 may be determined by the order in which invitees 208 submit an acceptance to participate in the media collage 112. Many such variations in the formulation, contents, and transmission of invitations may be devised by those of ordinary skill in the art, and included in various embodiments of the techniques presented herein.

### E3. Presentation and Handling of Invitations

A third aspect that may vary among embodiments of the techniques presented herein involves the presentation and handling of invitations 206 by the associate devices 216.

As a first variation of this third aspect, the associate device 216 may present, to the associate user 204, the invitation 206 including details such as a date and/or time, projected location, and/or subject of the media capture 106 to be captured by the associate device 216 for the media collage 112, as well as a media collage description 808 of the resulting media collage 112. The invitation 206 may specify such details at varying levels of specificity; e.g., the date and/or time of the capture may be specified precisely (such as at 12:00:00 am Eastern Standard Time on Aug. 29, 2016) or as a range (such as capturing a photo any time within the next 24 hours, or in the first week of March). The invitation 206 may also specify the other invitees 208 and/or the participants 212 who have accepted the invitation 206, as well as a media capture sequential order 810.

As a second variation of this third aspect, the associate device 216 may include options to the associate user 204 for responding to the invitation 206. As a first such example, the associate user 204 may accept or decline the invitation 206, and/or may opt into and/or opt out of the future receipt of invitations 206 for other media collages 112. As a second such example, the associate device 216 may permit the associate user 204 to agree to participate in the media collage 112 on an anonymous and/or pseudonymous basis (e.g., obscuring or altering the identity of the associate user 204 in the media capture 112 submitted for the media collage 112). As a third such example, the associate device 216 may permit the associate user 204 to participate as an observer, e.g., declining to submit a media capture 106 for the media collage 112 while requesting to view the completed media collage 112. As a third such example, the associate device 216 and/or the invitation 206 may permit the associate user 204 to suggest other individuals who are not currently among the associate users 204 but who may wish to participate in the media collage 112. In some scenarios, the suggestion of additional individuals may be transmitted to the initiating user 202 for approval, and/or to the other invitees 208 for approval by voting; in other scenarios, the associate user 204 may extend the invitation 206 to other individuals without prior approval.

As a third variation of this third aspect, an acceptance of the invitation 206 by the associate user 204 may result in various responses by the associate device 216. As a first such example, responsive to receiving the acceptance 210 from the associate user 204, the associate device 216 may store a media capture trigger to generate the media capture 106 at a media capture time in accordance with the invitation 206; and responsive to detecting an invocation of the media capture trigger, the associate device 216 may automatically generate the media capture 106 for the media collage 112. Alternatively or additionally, responsive to detecting the invocation of the media capture trigger, the associate device 216 may notify the associate user 204 of the invocation of the media capture trigger. As a second such example, responsive to receiving the acceptance from the associate user 204, the associate device 216 may transmit the acceptance from the associate user 204 to generate the media capture 106 in accordance with the invitation 206; and responsive to receiving, from the initiating user 202, a request to capture the media image 106 for the media collage 112, the associate device 216 may generate the media capture 106 for the media collage 112.

FIG. 9 is an illustration of an example scenario featuring several such variations in the presentation of the invitation by the associate device 216 to the associate user 204. As a first such example, the invitation provides a first option 902 to participate as a participant (e.g., submitting a media capture 106 for the media collage 112), while a second option 904 enables the associate user 204 to accept as a bystander (e.g., refraining from submitting a media capture 106, but requesting to view the media collage 112 generated by the participants 212). As further examples, the invitation 206 may present a third option 906 to invite other users, and a fourth option 908 to opt out of future invitations 210 to participate in media collages 12. As a still further example, an acceptance of the first option 902 may cause the associate device 216 to store a media capture trigger 910 that causes the associate device 216, at the date and/or time specified in the invitation 206, to generate and submit the media capture 106 for the media collage 112. Many such variations in the presentation and handling of the invitations 206 for media collages 112 may be utilized by those of ordinary skill in the art in various embodiments of the techniques presented herein.

### E4. Media Capture

A fourth aspect that may vary among embodiments of the techniques presented herein involves the manner in which the devices of the participants 212 (including the initiating user 202 and the associate users 204 who accept the invitation 206) to generate and submit the media capture 106 for the media collage 112.

As a first variation of this fourth aspect, an associate device 216 may receive a preceding media capture of a preceding participant 212 of the media collage 112 (e.g., one or more media captures 106 from participants 212 who precede the associate user 204 in a media capture sequential order). The associate device 216 may present the preceding media capture to the associate user 204 before generating the media capture 106 of the associate user 204 for the media collage 112, e.g., to provide ideas for the associate user 204 in generating the media capture 106 for the media collage 112, and/or for enabling an interactive experience among the associate user 204 and the other participants 212 during the collection of media captures. As one such example, the media collage server 602 may generate and transmit to the associate device 216 an intermediate media collage of the media captures 106 of at least two participants 212, e.g., a partial media collage 112 of the media captures 106 submitted thus far. The associate device 216 may present the intermediate media collage to the associate user 204 before generating the media capture 106 of the associate user 204 for the media collage 112.

As a second variation of this fourth aspect, before generating the media capture 106, the associate device 16 may present to the associate user 204 a participation option to currently capture the media image 106 (e.g., a notification that the time to generate the media capture 106 is imminent or has arrived). The associate device 216 may also generate the media capture 106 only responsive to receiving a selection of the participation option from the associate user 204. Alternatively or additionally, before generating the media capture 106, the associate device 216 may present to the associate user 204 a refraining option to refrain from currently capturing the media capture 106 (e.g., an option to postpone or cancel the media capture 106). The associate device 216 may, responsive to receiving a selection from the associate user 204 of the refraining option, at least temporarily refrain from generating the media capture 106.

As a third variation of this fourth aspect, the associate device 216 may present the media capture 106 to the associate user 204 prior to submission for the media collage 112. For example, the associate device 216 may condition the submission of the media capture 106 for the media collage 112 upon receiving, from the associate user 204, an acceptance of the media capture 106. Alternatively or additionally, the associate device 216 may present to the associate user 204 an option to generate a substitute media capture 106; and responsive to receiving, from the associate user 204, a selection of the option to generate a substitute media capture 106, the associate device 216 may generate a substitute media capture 106 using the media sensor 612. As a further variation, responsive to receiving, from the associate user 204, a message to accompany the media capture 106, the associate device 216 may submit the message of the associate user 204 with the media capture 106 for the media collage 112 (e.g., to annotate the media capture 106 included in the media collage 112, and/or for transmission to the other participants 212 in the media collage 112). As a still further variation, the associate device 216 may transmit with the media capture 106 various types of metadata, such as the location (e.g., geotag) of the media capture 106; details of the media capture 106, such as the physical position and/or orientation of the associate device 216 during the media capture 106; the equipment used for the media capture 106; and/or subjects recognized in the media capture 106, such as a recognition of individuals portrayed in the media capture 106 using a face recognition technique.

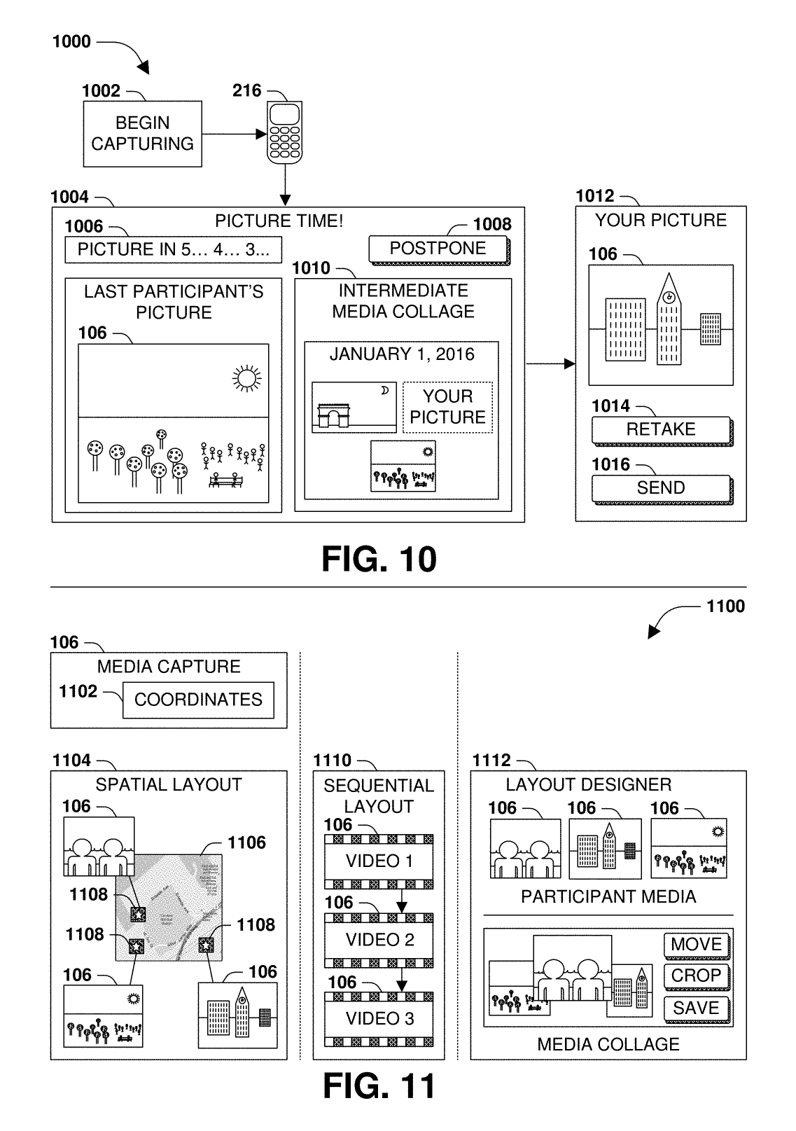

FIG. 10 presents an illustration of an example scenario 1000 featuring several variations in the media capture 106 by an associate device 216. In this example scenario 1000, an instruction to begin the media capture 1002 is received (e.g., from the initiating device 214 of the initiating user 202, from the media collage server 602, from the associate user 204, and/or from a media capture trigger 910 created within the associate device 216). The associate device 216 may present a notification 1004 of the media capture 106, including a countdown 1006 until the associate device 216 automatically generates the media capture 106, and/or a postponement option 1008 to postpone the media capture 106. The associate device 216 may also present the media capture 106 of the preceding participant 212, and/or an intermediate media collage 1010 generated from the media captures 106 collected thus far. Responsive to generating the media capture 106, the associate device 216 may present to the associate user 204 a second notification 1012 including the media capture 106 to be submitted for the media collage 112, as well as a first option 1014 to generate a substitute media capture 106, and a second option 1016 to submit the selected (first or substitute) media capture 106 for the media collage 112. Many such variations in the generation and submission of media captures 106 for the media collage 112 may be included in variations of the embodiments presented herein.

### E5. Media Capture Collection and Media Collage Generation

A fifth aspect that may vary among embodiments of the techniques presented herein involves the collection of media captures 106 and the generation of the media collage 112.

As a first variation of this fifth aspect, a media collage server 602 may, responsive to receiving a media capture 106 from a first participant 212, transmit the media capture 106 to a second participant 212 of the media collage 112. Alternatively or additionally, the media collage server 602 may, responsive to receiving a first media capture 106 from a first participant 212 and a second media capture 106 from a second participant 212, while awaiting a third media capture 106 from a third participant 212, combine at least the first media capture 106 and the second media capture 106 to generate an intermediate media collage, and transmit the intermediate media collage to at least one participant 212 of the media collage 106.

FIG. 11 presents a set of second variations of this fifth aspect, wherein the media collage server 602 generates the media collage 112 from the media captures 106 in a variety of ways. As a first such example, the media collage server 602 may spatially aggregate the respective media captures 106 to produce a spatial layout 1104 for the media collage 112 (e.g., arranging a set of images in a spatial arrangement according to the coordinates 1102 or locations where such images were captured to align the media captures 106 with locations 1108 on a map 1106, or sorting a set of media captures 106 by color). As a second such example, the media collage server 602 may chronologically aggregate the media captures 106 according to a sequential layout 1110 to produce a media collage chronological sequence (e.g., a slideshow of still images or a montage of video recordings), optionally with transitions such as a cross-fade between media captures 106 and/or an interactive timeline. As a third such example, the media collage server 602 and/or initiating device 214 may present, to the initiating user 202, a media collage designer user interface 1112 that allows the initiating user 202 or another participant 212 to aggregate the media captures 106 in various ways to generate the media collage 112.

As a third variation of this fifth aspect, a media collage server 602 may generate and transmit, with the media collage 112, a description of the respective media captures 106 that have been combined to generate the media collage 112. For example, the media collage server 602 may identify the individuals or subjects of the respective media captures 106 of the media collage 112 as detected by face recognition, voice recognition, and/or user selection. Many such variations may be included in the collection of media captures 106 and the generation of the media collage 112 therefrom in various embodiments of the techniques presented herein.

### E6. Media Collage Sharing

A sixth aspect that may vary among embodiments of the techniques presented herein involves the distribution of the media collage 112 to the participants 212.

As a first variation of this sixth aspect, a media collage server 602 may directly transmit the media collage 112 to the participants 212, such as via email, simple message service (SMS), or multimedia messaging service (MMS). Alternatively or additionally, the media collage server 602 may transmit a notification to the participants 212 of the completion of the media collage 112, and/or a location where the media collage 112 may be retrieved and/or viewed, such as a uniform resource identifier (URI).

As a second variation of this sixth aspect, if at least one participant 212 is associated with a social network, a media collage server 602 may, after generating the media collage 112, submit the media collage 112 to the social network on behalf of the at least one participant 212. The media collage server 602 may also submit, to the social network, an identification of at least one participant 212 or individual who is depicted in at least one media capture 106 of the media collage 112. Alternatively or additionally, the media collage server 602 may condition the transmission of the media collage 112 to the social network and/or the inclusion of such metadata upon receiving consent of the participant 212 and/or the depicted individual.

As a third variation of this sixth aspect, a media collage server 602 may receive and store comments by the participants 212 about the media collage 112, which may either pertain to the media collage 112 in general or to particular media captures 106 included therein. When a participant 212 later requests to view the media collage 112, the media collage server 602 may include the set of comments about the media collage 112 received to date from the participants 212 as an annotation to the media collage. Those of ordinary skill in the art may devise many such variations in the sharing of the media collage 112 that may be utilized in various embodiments of the techniques presented herein.

### F. Computing Environment

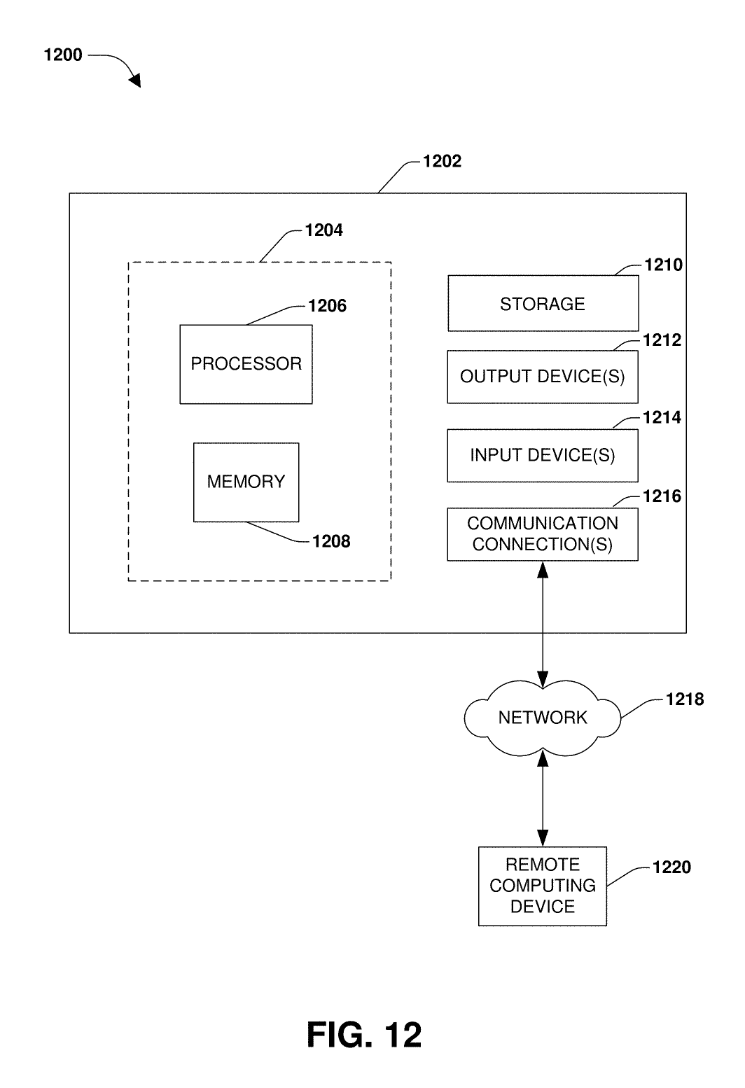

FIG. 12 and the following discussion provide a brief, general description of a suitable computing environment to implement embodiments of one or more of the provisions set forth herein. The operating environment of FIG. 12 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 12 illustrates an example of a system 1200 comprising a computing device 1202 configured to implement one or more embodiments provided herein. In one configuration, computing device 1202 includes at least one processing unit 1206 and memory 1208. Depending on the exact configuration and type of computing device, memory 1208 may be volatile (such as RAM, for example), non-volatile (such as ROM, flash memory, etc., for example) or some combination of the two. This configuration is illustrated in FIG. 12 by dashed line 1204.

In other embodiments, device 1202 may include additional features and/or functionality. For example, device 1202 may also include additional storage (e.g., removable and/or non-removable) including, but not limited to, magnetic storage, optical storage, and the like. Such additional storage is illustrated in FIG. 12 by storage 1210. In one embodiment, computer readable instructions to implement one or more embodiments provided herein may be in storage 1210. Storage 1210 may also store other computer readable instructions to implement an operating system, an application program, and the like. Computer readable instructions may be loaded in memory 1208 for execution by processing unit 1206, for example.

The term “computer readable media” as used herein includes computer storage media. Computer storage media includes volatile and nonvolatile, removable and non-removable media implemented in any method or technology for storage of information such as computer readable instructions or other data. Memory 1208 and storage 1210 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1202. Any such computer storage media may be part of device 1202.

Device 1202 may also include communication connection(s) 1216 that allows device 1202 to communicate with other devices. Communication connection(s) 1216 may include, but is not limited to, a modem, a Network Interface Card (NIC), an integrated network interface, a radio frequency transmitter/receiver, an infrared port, a USB connection, or other interfaces for connecting computing device 1202 to other computing devices. Communication connection(s) 1216 may include a wired connection or a wireless connection. Communication connection(s) 1216 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1202 may include input device(s) 1214 such as keyboard, mouse, pen, voice input device, touch input device, infrared cameras, video input devices, and/or any other input device. Output device(s) 1212 such as one or more displays, speakers, printers, and/or any other output device may also be included in device 1202. Input device(s) 1214 and output device(s) 1212 may be connected to device 1202 via a wired connection, wireless connection, or any combination thereof. In one embodiment, an input device or an output device from another computing device may be used as input device(s) 1214 or output device(s) 1212 for computing device 1202.

Components of computing device 1202 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1202 may be interconnected by a network. For example, memory 1208 may be comprised of multiple physical memory units located in different physical locations interconnected by a network.

Those skilled in the art will realize that storage devices utilized to store computer readable instructions may be distributed across a network. For example, a computing device 1220 accessible via network 1218 may store computer readable instructions to implement one or more embodiments provided herein. Computing device 1202 may access computing device 1220 and download a part or all of the computer readable instructions for execution. Alternatively, computing device 1202 may download pieces of the computer readable instructions, as needed, or some instructions may be executed at computing device 1202 and some at computing device 1220.

### G. Usage of Terms

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “example” is used herein to mean serving as an example, instance, or illustration. Any aspect or design described herein as “example” is not necessarily to be construed as advantageous over other aspects or designs. Rather, use of the word example is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated example implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. An initiating device that enables an initiating user to initiate a generation of a media collage using associate devices of associate users of the initiating user, the initiating device comprising:
a media sensor;
a processor; and
a memory storing instructions that, when executed by the processor, cause the initiating device to:
receive, from the initiating user, an invitee list of invitees selected from the associate users;
transmit, to respective invitees, an invitation to become a participant in the media collage;
generate a first media capture on behalf of the initiating user;
cause the first media capture to be combined with media captures by the associate devices of respective invitees who accepted the invitation to become a participant, wherein combining the first media capture and the media captures of the participants generates the media collage; and
present the media collage to the initiating user.

2. A method of generating a media collage using associate devices of associate users of an initiating user, the method involving an initiating device of the initiating user and comprising:
executing, on a processor of the initiating device, instructions that cause the initiating device to:
receive, from the initiating user, an invitee list of invitees selected from the associate users;
transmit, to respective invitees, an invitation to become a participant in the media collage;
generate a first media capture on behalf of the initiating user;
cause the first media capture to be combined with media captures by the associate devices of respective invitees who accepted the invitation to become a participant, wherein combining the first media capture and the media captures of the participants generates the media collage; and
present the media collage to the initiating user.

3. The method of claim 2, wherein:
the initiating device has access to an associate user list of associate users of the initiating user; and
receiving the selection of invitees further comprises:
among the associate users of the initiating user, identifying a subset of suggested invitees;
presenting, to the initiating user, a suggestion comprising the suggested invitees for the media collage; and
receiving, from the user, a selection of invitees among the suggested invitees.

4. The method of claim 3, wherein:
the media collage further comprises a collage of media captures of a selected media type; and
identifying the subset of suggested invitees further comprises:
for respective associate users of the initiating user, determine whether the the associate device of the associate user is capable of capturing the selected media type; and
identifying, among the associate users of the initiating user, the subset of suggested invitees having associate devices that are capable of capturing the selected media type.

5. The method of claim 3, wherein:
identifying the subset of suggested invitees further comprises: receiving, from the initiating user, a selection of a media capture sequential order in which the participants are to generate the media captures for the media collage; and
executing the instructions further causes the initiating device to transmit the media capture sequential order to the participants.

6. The method of claim 2, wherein:
executing the instructions further causes the device to receive, from the initiating user, a description of the media collage; and
transmitting the invitation to the respective invitees further comprises: transmitting, with the invitation, the description of the media collage by the initiating user.

7. An associate device that enables an associate user to participate in a media collage, initiating user to initiate a generation of a media collage using associate devices of associate users of the initiating user, the initiating device comprising:
a media sensor;
a processor; and
a memory storing instructions that, when executed by the processor, cause the associate device to:
responsive to receiving, from an initiating user, an invitation to become a participant in the media collage, present the invitation to the associate user;
responsive to receiving, from the associate user, an acceptance of the invitation:
using a media sensor, generate a media capture on behalf of the associate user; and
submit the media capture for the media collage; and
responsive to receiving the media collage including the media capture of the associate user, present the media collage to the associate user.

8. A method of enabling an associate user to participate in a media collage, the method involving an associate device having a processor and a media sensor, and the method comprising:
executing, on a processor of the associate device, instructions that cause the associate device to:
responsive to receiving, from an initiating user, an invitation to become a participant in the media collage, present the invitation to the associate user;
responsive to receiving, from the associate user, an acceptance of the invitation:
using the media sensor, generate a media capture on behalf of the associate user; and
submit the media capture for the media collage; and
responsive to receiving the media collage including the media capture of the associate user, present the media collage to the associate user.

9. The method of claim 8, wherein:
executing the instructions further causes the associate device to, responsive to receiving the acceptance from the user, store a media capture trigger to generate the media capture at a media capture time in accordance with the invitation; and
generating the media capture further comprises: responsive to detecting an invocation of the media capture trigger by the associate device, generating the media capture for the media collage.

10. The method of claim 9, wherein the instructions are further configured to, responsive to detecting the invocation of the media capture trigger, notify the associate user of the invocation of the media capture trigger.

11. The method of claim 8, wherein:
executing the instructions further causes the associate device to, responsive to receiving the acceptance from the user, transmit the acceptance from the associate user to generate the media capture in accordance with the invitation; and
generating the media capture further comprises: responsive to receiving, from the initiating user, a request to capture the media image for the media collage, generating the media capture for the media collage.

12. The method of claim 8, wherein executing the instructions further causes the associate device to, responsive to receiving, a preceding media capture of a preceding participant of the media collage, present the preceding media capture to the associate user before generating the media capture of the associate user for the media collage.

13. The method of claim 8, wherein executing the instructions further causes the associate device to, responsive to receiving, an intermediate media collage of the media captures of at least two participants, present the intermediate media collage to the associate user before generating the media capture of the associate user for the media collage.

14. The method of claim 8, wherein:
executing the instructions further causes the associate device to, before generating the media capture, present to the associate user a refraining option to refrain from currently capturing the media capture; and
generating the media capture further comprises: responsive to receiving, from the associate user, a selection of the refraining option, at least temporarily refraining from currently generating the media capture.

15. The method of claim 8, wherein generating the media capture further comprises:
before generating the media capture, present to the associate user a participation option to currently capture the media image; and
generating the media capture only responsive to receiving, from the associate user, a selection of the participation option.

16. The method of claim 8, wherein submitting the media capture for the collage further comprises:
presenting the media capture to the associate user;
responsive to receiving, from the associate user, an acceptance of the media capture, submit the media capture for the media collage on behalf of the associate user; and
responsive to receiving, from the associate user, a request to generate a substitute media capture: using the media sensor, generate a substitute media capture.

17. The method of claim 8, wherein submitting the media capture for the collage further comprises: responsive to receiving, from the associate user, a message accompanying the media capture, submit the message of the associate user with the media capture for the media collage.

18. A media collage server that generates a media collage using an initiating device of an initiating user and associate devices of participants, the media collage server comprising:
a processor; and
a memory storing instructions that, when executed by the processor, cause the media collage server to:
receive, from the initiating user, a selection of invitees;
transmit, to respective invitees, an invitation to become a participant in the media collage;
responsive to receiving, from a selected invitee, a response that accepts the invitation, designate the selected invitee as a participant of the media collage; and
responsive to receiving, from the participants, media captures submitted for the media collage:
combine the media captures of the participants to generate the media collage; and
transmit the media collage to the participants.

19. A method of generating a media collage using an initiating device of an initiating user and associate devices of participants, the method involving a media collage server having a processor, the method comprising:
executing, on the processor, instructions that cause the media collage server to:
receive, from the initiating user, a selection of invitees;
transmit, to respective invitees, an invitation to become a participant in the media collage;
responsive to receiving, from a selected invitee, a response that accepts the invitation, designate the selected invitee as a participant of the media collage; and
responsive to receiving, from the participants, media captures submitted for the media collage:
combine the media captures of the participants to generate the media collage; and
transmit the media collage to the participants.

20. The method of claim 19, wherein executing the instructions further causes the server to: responsive to receiving a media capture from a first participant, transmit the media capture to a second participant of the media collage.

21. The method of claim 19, wherein executing the instructions further causes the server to: responsive to receiving a first media capture from a first participant and a second media capture from a second participant, while awaiting a third media capture from a third participant:
combine the first media capture and the second media capture to generate an intermediate media collage; and
transmit the intermediate media collage to at least one participant.

22. The method of claim 19, wherein combining the media captures of the participants to generate the media collage further comprises: spatially aggregating the respective media captures to produce a spatial layout media collage.

23. The method of claim 19, wherein combining the media captures of the participants to generate the media collage further comprises: chronologically aggregating the respective media captures to produce a media collage chronological sequence.

24. The method of claim 19, wherein combining the media captures of the participants to generate the media collage further comprises: presenting, to the initiating user, a media collage designer user interface that allows the initiating user to aggregate the media captures to generate the media collage.

25. The method of claim 19, wherein combining the media captures of the participants to generate the media collage further comprises: generating, for the media collage, a description of the respective media captures that have been combined to generate the media collage.

26. The method of claim 19, wherein:
at least one participant is associated with a social network; and
executing the instructions further causes the media collage server to, after generating the media collage, submit the media collage to the social network on behalf of the at least one participant.

27. The method of claim 26, wherein submitting the media collage to the social network further comprises: submitting, to the social network, an identification of at least one participant who is depicted in at least one media capture of the media collage.
